(19) United States
(12) Patent Application Publication
(10) Pub. No.: US 2026/0235468 A1
(43) Pub. Date: Aug. 13, 2026

(54) TECHNIQUES FOR LEAK DETECTION OF A COMPOUND

(71) Applicant: Honeywell International Inc., Charlotte, NC (US)

(72) Inventors: Sandhya Beejady, Bangalore (IN); Akhilesh Singh, Secunderabad (IN); Rajapriyan Thambidurai, Bangalore (IN); Dhandapani Krishnasamy, Hosur (IN); Sridhar Sankaranarayanan, Bangalore (IN); Sravan Myneni, Bangalore (IN)

(21) Appl. No.: 19/185,262

(22) Filed: Apr. 22, 2025

(30) Foreign Application Priority Data
Feb. 13, 2025 (IN) 202511012443

(51) Int. Cl. G01M 3/04

(52) U.S. Cl. CPC G01M 3/04

(57) ABSTRACT

Techniques for instantaneous leak detection of a compound associated with an asset are described. In one aspect, data streams from multiple sensing elements associated with the asset are received, where the multiple sensing elements are to detect leak attributes corresponding to the compound, a leak attribute being indicative of a potential leak of the compound. A first set of data streams including at least one leak attribute from amongst a pre-defined set of leak attributes are identified and monitored in real-time to identify a change in value of the said leak attribute. The change in value of the leak attribute is analysed to determine presence of a leak. Further, a data stream associated with the at least one leak attribute is identified to trace sensing elements amongst the multiple sensing elements associated with said data stream, based on which the leak is contextualized and provided to a user interface.

### BACKGROUND

Leak detection of compounds such as liquids and gases are widely used in various industries for identifying and localizing unintended releases of materials from containment systems, pipelines, or equipment. Leak detection techniques are widely utilized in various industrial operations, particularly in sectors dealing with hazardous or valuable materials such as oil and gas, chemical manufacturing, pharmaceutical production, wastewater treatment, refrigeration, and the like. Undetected leaks can lead to significant environmental impacts, safety concerns, product loss, and regulatory non-compliance.

### SUMMARY

Aspects of the present subject matter provide techniques for instantaneous leak detection of a compound associated with an asset operating in a facility.

According to an example of the present subject matter, a method for leak detection of a compound associated with an asset is provided. The method includes receiving data streams from a plurality of sensing elements associated with the asset, where the plurality of sensing elements are to at least detect leak attributes corresponding to the compound. A leak attribute being indicative of a potential leak of the compound. A first set of data streams which includes at least one leak attribute from amongst a pre-defined set of leak attributes is identified. The first set of data streams are monitored in real-time to identify a change in value of the at least one leak attribute. Further, the change in value of the at least one leak attribute is analyzed to determine presence of a leak of the compound. On determining the presence of a leak, a data stream associated with the at least one leak attribute is identified to trace sensing elements amongst the plurality of sensing elements associated with said data stream. The leak is contextualized based at least on the traced sensing elements and provided to a user interface.

According to another example of the present subject matter, a leak detection system is provided. The system includes a processor and memory coupled to the processor, where the processor causes to receive data streams from a plurality of sensing elements associated with an asset, where the plurality of sensing elements are to at least detect leak attributes corresponding to a compound associated with the asset, a leak attribute being indicative of a potential leak of the compound. Further, the processor is to identify a first set of data streams which includes one or more leak attributes from amongst a pre-defined set of leak attributes, where the first set of data streams includes a first set of leak attributes amongst the pre-defined set of leak attributes and where each data stream amongst the first set of data streams includes at least one leak attribute. The first set of data streams are monitored in real-time to identify a change in value of at least one leak attribute from amongst the first set of leak attributes. The system analyzes the change in value of the at least one leak attribute in conjunction with values of other leak attributes from the first set of leak attributes to determine presence of a leak of the compound. Further, data streams associated with the leak attributes used to determine the presence of the leak are identified to trace sensing elements amongst the plurality of sensing elements associated with the said data streams. Thereafter, the leak is contextualized based at least on the traced sensing elements and provided to a user interface.

According to another example of the present subject matter, a non-transitory computer readable medium containing program instruction for leak detection of a compound associated with an asset is provided, the instructions being executable by a processor to receive data streams from a plurality of sensing elements associated with the asset, where the plurality of sensing elements are to at least detect leak attributes corresponding to the compound, a leak attribute being indicative of a potential leak of the compound, identify a first set of data streams which includes at least one leak attribute from amongst a pre-defined set of leak attributes, monitor the first set of data streams in real-time to identify a change in value of the at least one leak attribute, analyze the change in value of the at least one leak attribute over a predetermined time period, determine presence of a leak of the compound when the change in value of the at least one leak attribute persists for the predetermined time period, identify a data stream associated with the at least one leak attribute to trace sensing elements amongst the plurality of sensing elements associated with the said data stream, contextualize the leak based at least on the traced sensing elements, and provide the contextualized leak to a user interface.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates a supply chain network environment, in accordance with an example implementation of the present subject matter.

FIG. 2 illustrates an example supply chain network, in accordance with an example implementation of the present subject matter.

FIG. 3 illustrates a leak detection system, in accordance with an example implementation of the present subject matter.

FIG. 4 illustrates a schematic for leak detection of a compound associated with an asset of the facility, in accordance with an example of the present subject matter.

FIG. 5 illustrates an example method for leak detection of a compound associated with an asset, in accordance with an example of the present subject matter.

FIG. 6 illustrates another example method for leak detection of a compound associated with an asset, in accordance with an example of the present subject matter.

FIG. 7 illustrates an example method for identifying a recurring leak, in accordance with an example implementation of the present subject matter.

FIG. 8A illustrates another example method for leak detection of a compound associated with an asset, in accordance with an example implementation of the present subject matter.

FIG. 8B illustrates a continuation of the method in FIG. 8A for leak detection of a compound associated with an asset, in accordance with an example implementation of the present subject matter.

FIG. 9 illustrates another example method for leak detection of a compound, in accordance with an example of the present subject matter.

FIG. 10 illustrates a non-transitory computer-readable medium for leak detection of a compound associated with an asset, in accordance with an example of the present subject matter.

### DETAILED DESCRIPTION

The present subject matter relates to techniques of instantaneous leak detection of a compound associated with an asset operating in a facility. Generally, industrial facilities encompass a network of sites including processing plants, storage terminals, distribution centers, and production hubs that collectively work to manufacture, process, and deliver products across various sectors. These facilities, such as chemical processing plants, oil and gas refineries, food and beverage industrial plants, pharmaceutical manufacturing units, and the like, often house equipment and infrastructure that are integral to their operations and productivity. During the operational lifetime of these assets, leaks may occur due to various factors, including but not limited to wear and tear, sudden failures, environmental conditions, or operational errors. These leaks may impact the efficiency, safety, and environmental compliance of the facility, as well as lead to product loss and increased operating costs. Leak events can occur unexpectedly and may vary in severity, from minor seepages to significant releases, affecting the integrity of the systems, the quality of products, and the overall performance of the facility. Consequently, the ability to detect and respond to leaks instantaneously is important for maintaining enhanced operational efficiency and regulatory compliance in industrial settings.

Traditional approaches for leak detection often rely on scheduled inspections. These scheduled inspections may result in some leaks in the system going unnoticed until the next scheduled inspection. This delay in detection may lead to product loss, environmental impacts, safety risks, and financial losses, especially for valuable or hazardous compounds, for example, like methane. Moreover, in cases involving potentially harmful gas types, the lack of prompt detection can result in serious safety events that could have been mitigated with earlier detection. For example, if a first scheduled leak detection takes place at 10:00 am, and the next inspection is scheduled after 4 hours, at 2:00 pm, any leak which may start between two consecutive scheduled inspections, for example, at 10:30 am, may go unnoticed until the next scheduled inspection takes place. Additionally, in large industrial settings where multiple leaks may occur simultaneously, such delayed detections may make it challenging for operators to quickly assess and prioritize their response efforts.

Further, a lack of comprehensive, real-time insights into leak events makes it difficult for operators to make informed decisions that can optimize leak detection and response, and in turn, the operations of the overall facility. The lack of prompt detection and real-time analysis may hamper the ability to quickly diagnose and address leak issues. Also, traditional techniques may not address monitoring and managing a diverse range of leaks in real-time. Each type of leak may have a distinct set of rules that may need to be considered. For example, different compounds or gases may require distinct detection thresholds, response protocols, and mitigation strategies. Consequently, monitoring and managing multiple leaks with varying characteristics and rule sets simultaneously in real-time may present significant challenges.

Accordingly, the present subject matter provides techniques to facilitate instant leak detection. Assets in facilities handling compounds, such as methane for example, can be monitored using various types of sensors. These sensors might include leak detection sensors, satellites, drones, Gas Cloud Imaging (GCI) cameras, and other sensing devices. Each type of sensor typically works with multiple sensing elements to detect the compound of interest. Data streams from these multiple sensing elements are received, filtered, and analyzed to identify potential leaks. In addition to detecting leaks, the system also contextualizes them in real-time, which may include information about the leak's location, the specific asset involved, and the facility where the leak occurred, among other details. This approach allows for comprehensive monitoring and rapid response to leaks, thereby effectively and efficiently managing safety, environmental impact, and operational efficiency in facilities handling potentially hazardous or valuable compounds.

In operation, to detect a leak of a compound, for example, a gaseous compound, associated with an asset, multiple data streams from multiple sensing elements associated with the asset may be received. Each of these sensing elements may sense and collect multiple leak attributes corresponding to the compound, where a leak attribute is indicative of a potential leak of the compound.

Upon receiving multiple data streams from various sensing elements, a first set of data streams that contain at least one leak attribute from a pre-defined set of leak attributes may be identified. This pre-defined set of leak attributes may encompass various parameters indicative of potential leaks. For example, a data stream from leak detection sensors might include a leak rate that requires monitoring, while a data stream from Gas Cloud Imaging (GCI) sensors may contain ongoing flags associated with events that need attention. These attributes such as leak rates, flags, and similar indicators constitute the pre-defined set of leak attributes. Identifying and focusing on a specific set of data streams with relevant leak attributes can substantially reduce the computational resources required for leak detection, thereby allowing efficient processing of large volumes of sensor data, potentially enabling faster response times and more effective real-time monitoring while optimizing system performance and resource utilization.

In one example, multiple leak attributes from the pre-defined set of leak attributes may be identified and ordered in correspondence to a time of detection for each leak attribute. The ordered leak attributes may further be grouped based on the mode of sensing. For example, all attributes obtained from leak detection sensors may be grouped together, while all attributes from GCI sensors may form another group, and so on. Ordering and grouping leak attributes by time and sensing mode facilitates efficient data processing and analysis, thereby enabling effective leak detection and characterization across different sensor types.

Further, the first set of data streams are monitored in real time, to identify a change in value of the at least one leak attribute. The change in value of the at least one leak attribute may be determined to determine presence of a leak of the compound. For example, the data stream obtained from the sensing elements associated with leak detection sensors may be continuously monitored to detect changes in the leak rate of the compound. In one example, when the leak rate changes from zero to a non-zero value, an onset of the leak may be detected. In one example, the change in value of each leak attribute may be analyzed based on comparing the change in value of the said leak attribute with a set of pre-determined rules to determine presence of a leak. Each leak attribute may be analyzed using different pre-determined rules to assess the start of a leak. In one example, the pre-determined rules may be based on the type of sensing mode. For instance, a rule for point sensors to detect the presence of a leak may vary from the rule for a GCI sensor to detect the presence of the leak. As would be understood, the leak attribute may either be detected from the data stream or may be calculated based on another parameter in the data stream.

Further, in one example, the leak rate may be calculated based on the change in value of the at least one leak attribute and a quantity of the compound leaked may be estimated based on the said leak rate and a duration of the leak. Further, to determine a criticality of the leak, it may be determined whether the leak rate exceeds a predetermined threshold within a specified time period, based on which the leak may be flagged as a critical leak event.

On determining the presence of a leak of the compound, the data stream associated with the at least one leak attribute may be identified to trace sensing elements from the multiple sensing elements associated with said data stream based on which the leak may be contextualized. The contextualized leak may then be provided to a user interface. In one example, contextualizing the leak includes associating the leak with at least one of a leak ID, location of the leak, a leak start time, a leak end time, a leak area, a leak gas type, and a leak rate. In one example, an asset associated with the traced sensing elements may be identified and a location of the asset within a site may be determined. The contextualized leak may then be updated with the asset and location information of the leak. In one example, a work order based on the contextualized leak may be generated. The work order may include, for example, detailed information such as safety precautions, required equipment, estimated repair time, and potential impact on facility operations. The work order may then be assigned to maintenance personnel for leak remediation and a status of the work order until the leak is resolved may be tracked. Additionally, whether a leak is recurrent or not may also be analyzed. In one example, this analysis may be performed by comparing characteristics associated with the leak determined and a historical leak. The contextualized leak may be updated accordingly, by for example, marking the said leak as a recurrent leak or a non-recurrent leak, and the like. Additionally, in one example, the contextualized leak may be converted into leak emission data by calculating an equivalent amount of greenhouse gas emissions based on characteristics of the compound and the contextualized leak.

Therefore, techniques of the present subject matter facilitate instant monitoring of assets and real-time detection of leaks across several types of compounds and sensing modes providing improved safety, reduced environmental impact, minimized product loss, and enhanced regulatory compliance across a wide range of industrial facilities. By integrating multiple data streams from diverse sensing elements, techniques of the present subject matter provide for comprehensive leak detection. Further, contextualizing leaks, generating work orders, and analyzing recurrence patterns further enhance proactive leak management. Techniques of the present subject matter also reduce the number of computational resources by incorporating data filtering techniques by identifying relevant data streams for leak identification, to enable efficient processing and faster response times, allowing for effective leak detection and management while optimizing system performance and resource utilization.

The above and other features, aspects, and advantages of the subject matter will be explained with regard to the following description and accompanying figures. It should be noted that the description and figures merely illustrate the principles of the present subject matter along with examples described herein and should not be construed as a limitation to the present subject matter. It is thus understood that various arrangements may be devised that, although not explicitly described or shown herein, embody the principles of the present disclosure. Moreover, all statements herein reciting principles, aspects, and examples thereof, are intended to encompass equivalents thereof. Further, for the sake of simplicity, and without limitation, the same numbers are used throughout the drawings to reference like features and components.

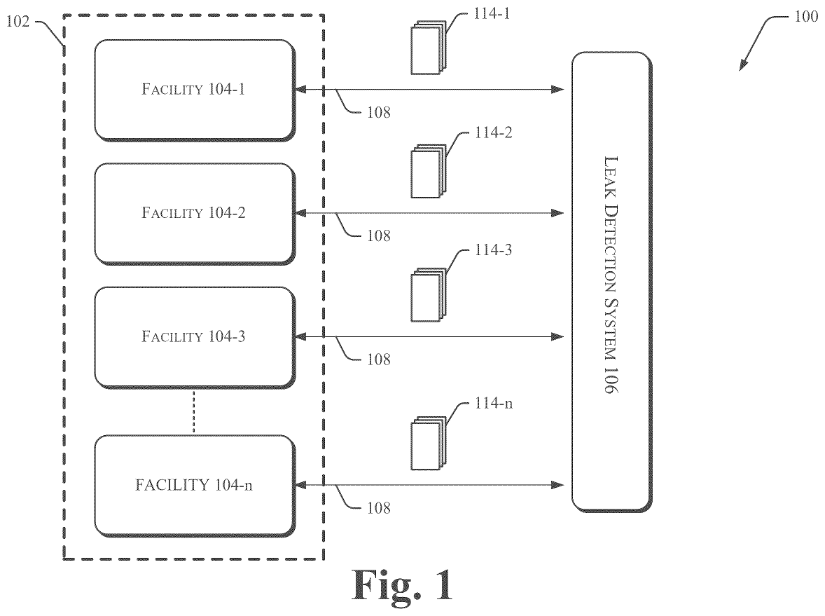

FIG. 1 illustrates a supply chain network environment 100, in accordance with an example implementation of the present subject matter. In one example, the supply chain network environment 100 may include a supply chain network 102 including multiple facilities, 104-1, 104-2, 104-3, . . . 104-n, collectively and alternatively referred to as multiple facilities 104 or facility 104. For example, but not limited to, the facility 104 may be an industrial plant, a wastewater treatment plant, an oil and gas refinery, a chemical processing unit, a pharmaceutical manufacturing unit, refrigeration handling units, and the like. In one example, the multiple facilities 104 may be distributed across various locations in the supply chain network 102.

Each facility of the multiple facilities 104 may include a facility management system (not shown in the figure). In one example, the facility management system may be employed in each facility 104 for instant leak detection of a compound associated with an asset operating in the facility 104. In one example, the facility management system may be part of a source device (not shown in the figure), where the source device may be an Internet of things (IOT) device, a computing device, a personal computer, a laptop, a tablet, a mobile phone, and the like. In another example, the facility management system may be hosted on a server (not shown in the figure) that may communicate with the source device.

In one example, the facility management system of each of the multiple facilities 104 may be communicatively coupled to a leak detection system 106. The facility management systems and the leak detection system 106 may communicate over a network 108. The network 108 may be a wireless network or a combination of a wired and wireless network. The network 108 can also include a collection of individual networks, interconnected with each other and functioning as a single large network, such as the Internet. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), Long Term Evolution (LTE), and Integrated Services Digital Network (ISDN). Depending on the terminology, the communication network includes various network entities, such as gateways and routers; however, such details have been omitted to maintain the brevity of the description.

Further, the leak detection system 106 may be implemented in any computing system, such as a storage array, a server, a desktop or a laptop, a computing device, a distributed computing system, or the like. Although not depicted, the leak detection system 106 may include other components, such as interfaces to communicate over the network or with external storage or computing devices, display, input/output interfaces, operating systems, applications, data, and other software or hardware components (not depicted for the sake of brevity).

In one example, the leak detection system 106 may obtain data 114-1, 114-2, 114-3, . . . , 114-n, collectively referred to as data 114, from multiple facilities 104-1, 104-2, 104-3, . . . 104-n, respectively. In one example, the data 114 generated by the multiple facilities 104, amongst other information, may include information associated with the operations, assets, and processes of the facility. For example, in a facility, such as an oil and gas refinery, the data 114 could indicate different types of assets commissioned in the refinery, maintenance logs of the various assets, location of each asset across the refinery, compounds being dealt with such as type of gas, or oil, and the like, historical leak data, historical mitigation efforts, personnel data, root cause analysis reports for previous faults, asset repair records, energy consumption patterns during normal conditions and fault conditions, historical emission data, regulatory requirements to be met, risk assessment reports, costs associated with handling various compounds and assets of the refinery, production data, processes of the facility, and the like.

Upon receiving the data 114 from the facilities 104 within the supply chain network 102, the leak detection system 106 may analyze the data 114 to instantaneously detect the presence of a leak associated with any asset operating in a facility 104, as well as on the supply chain network 102. In one example, the facility 104 may have multiple assets, and each asset may be monitored by multiple types of sensing modes, such as a GCI camera, a position sensor, a drone, a satellite and the like. Each type of sensing mode may further be associated with multiple sensing elements, like the GCI camera may be associated with multiple sensors, and the like. Data streams from the array of multiple sensors may be monitored, filtered, and analyzed, in real-time, for instantaneous leak detection of various compounds associated with the assets. On determining the presence of a leak, the leak is contextualized to associate the leak with an asset, and in turn, a facility. Further, the leak may be contextualized by associating the leak with attributes such as a leak ID, location of the leak, a leak start time, a leak end time, a leak area, a leak gas type, and a leak rate, and the like. In one example, this information may then be provided to a user interface, and in turn may be relayed to a personnel of the facility to initiate mitigation of the leak.

Therefore, techniques of the present subject matter facilitate instant monitoring of assets and real-time detection of leaks across several types of compounds and sensing modes providing improved safety, reduced environmental impact, minimized product loss, and enhanced regulatory compliance across a wide range of industrial facilities. Further, the real-time nature of the analysis enables proactive maintenance strategies, potentially preventing minor leaks from escalating into major incidents.

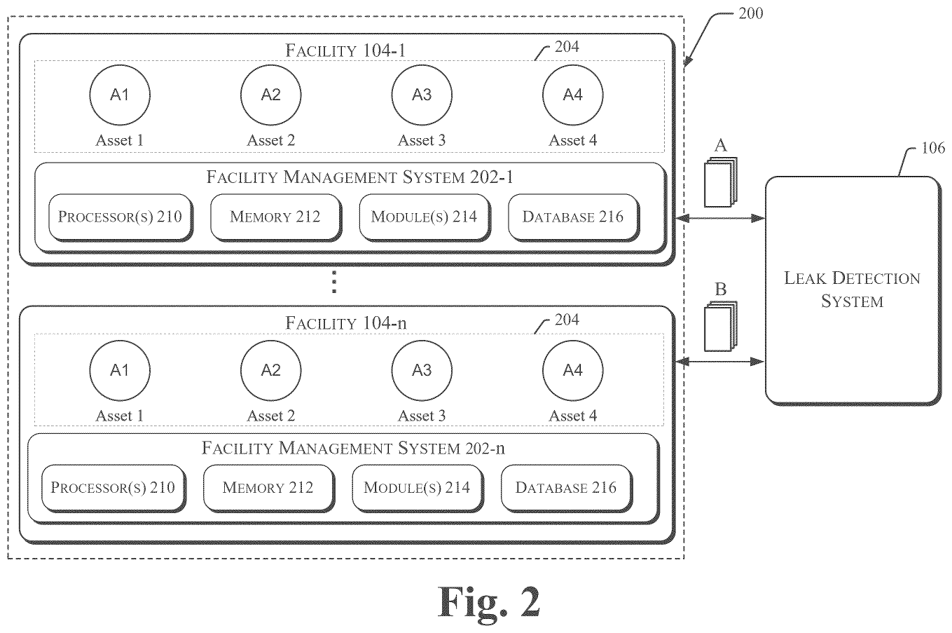

FIG. 2 illustrates an example supply chain network 102, in accordance with an example implementation of the present subject matter. In one example, the supply chain network 200 depicts Facility 104-1 and Facility 104-n communicatively coupled to the leak detection system 106. For the sake of simplicity, the following description has been predominantly discussed with reference to Facility 104-1 and Facility 104-n of the supply chain network 200, communicatively coupled to the leak detection system 106. However, similar principles may be applicable to all facilities of a supply chain network 200 coupled to the leak detection system 106.

In one example, Facility 104-1 of the supply chain network 200 may be located in a first geographical location and Facility 104-n may be located in a second geographical location of the supply chain network 200. Each of the facilities, Facility 104-1, and Facility 104-n, may include a facility management system 202-1, 202-n, respectively. In one example, the facility management system 202-1 of Facility 104-1 and the facility management system 202-n of Facility 104-n may be communicatively coupled to the leak detection system 106.

Further, Facility 104-1 and Facility 104-n within the supply chain network 200 may include a plurality of assets depicted as Asset 1, Asset 2, Asset 3, and Asset 4, collectively referred to as asset 204, associated with the various operations of the facility. In one example, Facility 104-1 may include a chemical processing plant with assets such as distillation columns, reactors, storage tanks, and pipelines and Facility 104-n may be an oil refinery with assets including crude oil distillation units, catalytic crackers, and hydrotreaters, and the like.

Each facility may have multiple sensors monitoring different compounds associated with these assets. For instance, in Facility 104-1, the distillation column may be equipped with temperature sensors at various stages, pressure sensors, and flow meters. Additionally, gas chromatographs may be installed to monitor the composition of vapors at different points in the column. The reactors may have sensors for temperature, pressure, pH, and specific gas concentrations relevant to the chemical processes. Storage tanks may be fitted with level sensors, pressure sensors, and gas detectors for volatile organic compounds (VOCs). Similarly, in Facility 104-n, the crude oil distillation unit may have temperature sensors along the distillation tower, pressure sensors, and flow meters for various product streams. Infrared cameras may be used for detecting hydrocarbon leaks. The catalytic cracker may be monitored with temperature sensors, pressure sensors, and catalyst activity sensors. Hydrotreaters may have hydrogen sulfide (H2S) detectors, temperature sensors, pressure sensors, and the like.

Data A and data B from each of these assets commissioned in Facility 104-1 and Facility 104-n may be collected by the facility management systems 202-1 and 202-n, respectively. For the sake of simplicity, the following description has been discussed with reference to the facility management system 202-1 of Facility 104-1, of the supply chain network 200. However, it may be understood that similar principles may be applicable to all other facilities 104 of the supply chain network 200. In one example, the facility management system 202-1 includes a processor 210 and a memory 212. The processor(s) 210 may be provided through the use of dedicated hardware as well as hardware capable of executing instructions. When provided by a processor, the functions may be provided by a single dedicated processor, by a single shared processor, or by a plurality of individual processors, some of which may be shared. Moreover, explicit use of the term “processor” would not be construed to refer exclusively to hardware capable of executing instructions, and may implicitly include, without limitation, digital signal processor (DSP) hardware, network processor, application specific integrated circuit (ASIC), field programmable gate array (FPGA), read only memory (ROM) for storing instructions, random access memory (RAM), non-volatile storage. Other hardware, standard and/or custom, may also be included. The memory 212 may include any computer-readable medium including, for example, volatile memory (e.g., RAM), and/or non-volatile memory (e.g., EPROM, flash memory, etc.).

The facility management system 202-1 may further include modules 214, such as an asset monitoring module, process flow control module, data integration module, and the like (not shown). In one example, the modules 214 may be implemented as a combination of hardware and firmware. In examples described herein, such combinations of hardware and firmware may be implemented in several different ways. For example, the firmware for the module 214 may be processor 210 executable instructions stored on a non-transitory machine-readable storage medium and the hardware for the module 214 may include a processing resource (for example, implemented as either a single processor or a combination of multiple processors), to execute such instructions.

In the present examples, the machine-readable storage medium may store instructions that, when executed by the processing resource, implement the functionalities of the modules 214. In such examples, the facility management system 202-1 may include the machine-readable storage medium storing the instructions and the processing resource to execute the instructions. In other examples of the present subject matter, the machine-readable storage medium may be located at a different location but accessible to the facility management system 202-1 and the processor(s) 210.

The facility management system 202-1 may further include a database 216, that serves, amongst other things, as a repository for storing data A that may be fetched, processed, received, or generated by the modules. For example, but not limited to, considering the example of the distillation column in the Facility 104-1, data A collected from the said asset may include temperature profiles, pressure readings, flow rates, and vapor composition at different stages, similarly, reactor data may include reaction temperatures, pressures, pH levels, and concentrations of specific gases, location of the distillation column and reactor, historical leaks associated with the assets, past maintenance records, efficiency of the asset, age of the asset, environmental conditions surround the asset and facility, different mitigation actions carried out historically on the said asset, and the like.

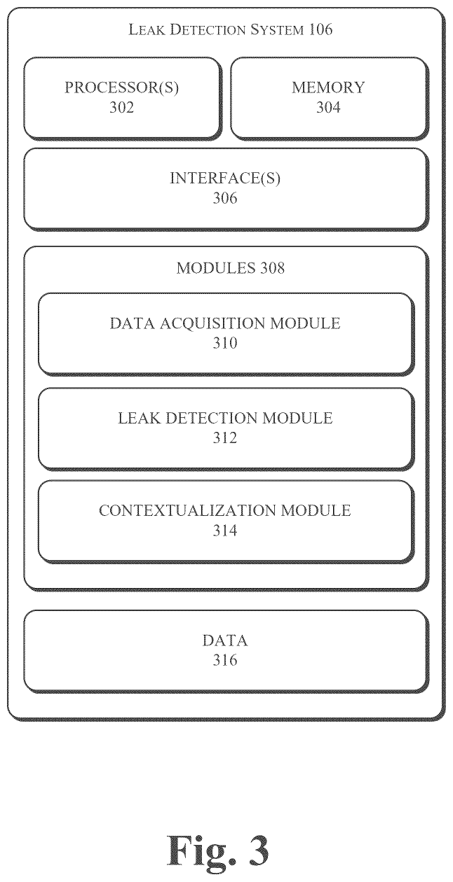

In one example, the facility management system 202a of Facility 104-1 may integrate and store all the data A collected from multiple assets in the database 216 of the facility management system 202a. Similarly, data B from the multiple assets 204 associated with Facility 104-n of the supply chain network 102 may be collected and stored in the facility management system 202-n. In one example, data A from Facility 104-1, data B from Facility 104-n of the supply chain network 102 may be communicated to the leak detection system 106. In one example, the leak detection system 106 may be a part of the facility management system 202. In another example, the leak detection system 106 may be hosted on another system, another server, or cloud, and may be accessed by the facility management system 202. Based on such data obtained from the facility management systems 202-1 and 202-n, the leak detection system 106 may analyze the data for instantaneous leak detection of compounds associated with the assets. The leak detection system 106 has been discussed with reference to FIG. 3.

FIG. 3 illustrates a leak detection system 106, in accordance with an example implementation of the present subject matter. The leak detection system 106, alternatively referred to as system 106, is to instantly and accurately determine the presence of a leak of a compound. The facility, such as an industrial facility, may include assets such as natural gas pipelines, ammonia refrigeration systems, hydrogen storage tanks, chlorine processing units, carbon dioxide storage vessels, anaerobic digesters in wastewater treatment plants, sulphur recovery units, oil storage tanks, oil pipelines, and the like. These assets may be equipped with various sensors and monitoring systems to detect leaks promptly, ensuring safety, environmental protection, and operational efficiency within the facilities.

In one example, the system 106 may include a processor 302 and a memory 304 coupled to the processor 302. The functions of functional block labelled as “processor(s)”, may be provided through the use of dedicated hardware as well as hardware capable of executing instructions. When provided by a processor, the functions may be provided by a single dedicated processor, by a single shared processor, or by a plurality of individual processors, some of which may be shared. Moreover, explicit use of the term “processor” would not be construed to refer exclusively to hardware capable of executing instructions, and may implicitly include, without limitation, digital signal processor (DSP) hardware, network processor, application specific integrated circuit (ASIC), field programmable gate array (FPGA), read only memory (ROM) for storing instructions, random access memory (RAM), non-volatile storage. Other hardware, standard and/or custom, may also be included. Further, an interface(s) 306 may allow the connection or coupling of the system 106 with one or more other devices (say devices or systems within the supply chain network), through a wired (e.g., Local Area Network, i.e., LAN) connection or through a wireless connection (e.g., Bluetooth®, Wi-Fi). The interface(s) 306 may also enable intercommunication between different logical as well as hardware components of the system 106.

The memory 304 may include any computer-readable medium including, for example, volatile memory (e.g., RAM), and/or non-volatile memory (e.g., EPROM, flash memory, etc.).

The system 106 may include modules 308, such as a data acquisition module 310, a leak detection module 312, and a contextualization module 314. The module(s) 308, in one example, may be implemented as a combination of hardware and firmware. In examples described herein, such combinations of hardware and firmware may be implemented in several different ways. For example, the firmware for the module may be processor executable instructions stored on a non-transitory machine-readable storage medium and the hardware for the module may include a processing resource (for example, implemented as either a single processor or a combination of multiple processors), to execute such instructions.

In the present examples, the machine-readable storage medium may store instructions that, when executed by the processing resource, implement the functionalities of the module(s) 308. In such examples, the system 106 may include the machine-readable storage medium storing the instructions and the processing resource to execute the instructions. In other examples of the present subject matter, the machine-readable storage medium may be located at a different location but accessible to the leak detection system 106 and the processor 302.

The system 106 may further include data 316, that serves, amongst other things, as a repository for storing data that may be fetched, processed, received, or generated by the modules 308. The data 316 may include real-time sensor readings, calibration data for sensors, contextual asset information, environmental measurements, leak characterization metrics, compound concentration levels, pressure and temperature readings from various equipment, infrared imaging data, optical gas imaging video streams, detection thresholds for various compounds, leak event identifiers, GPS coordinates of detected emissions, asset identifiers and types, operational status of monitored equipment, maintenance logs, wind speed and direction, ambient conditions, leak duration and mass calculations, gas type identifications, historical leak data, leak status flags, severity classifications, automated alerts, equipment specifications, data associated with the process of Leak Detection and Repair (LDAR), manufacturer data, expected emission profiles under normal operating conditions, regulatory compliance thresholds, and the like. In an example, the data 316 may be stored in the memory 304.

In one example, the data acquisition module 310 of the leak detection system 106 may receive data streams from a plurality of sensing elements associated with the asset. Each asset may be monitored by different types of sensing modes, such as a GCI camera, position leak detection sensors, satellites, drones, and the like. Each sensing mode may be associated with multiple sensing elements or sensors, from which data streams originate. Data streams originating from multiple sensors associated with different types of sensing modes, monitoring compounds associated with multiple assets spread across various facilities, may be obtained and analyzed in real-time. Such data streams, in one example, may be obtained directly from the sensing elements. In another example, data streams from the sensing elements may be stored in a database. Each type of sensing mode may be associated with a database, from which the system 106 may obtain these data streams.

The multiple sensing elements may be to detect leak attributes corresponding to a compound being monitored. A leak attribute being indicative of a potential leak of the compound. For example, if the asset is being monitored by a leak detection sensor, leak rate may be identified as the leak attribute. Similarly, if the asset is being monitored by a GCI camera, a flag status on the occurrence of a leak event may be identified as the leak attribute, and the like. Although the description has been predominantly described with reference to leak rate and a flag status as leak attributes, it would be understood that similar principles of the present subject matter would be applicable to all other leak attributes and is not to be construed as a limitation.

On obtaining multiple data streams from multiple sensors associated with an asset, the leak detection module 312 may identify a first set of data streams which includes at least one leak attribute, amongst all the other data streams that may be generated by the sensors. Further, the first set of data streams may include at least one leak attribute from amongst a pre-defined set of leak attributes. The pre-defined set of leak attributes may include attributes that are indicative of a potential leak of the compound being monitored. The pre-defined set of leak attributes would vary based on, for example but not limited to, the type of asset being monitored, the type of compound being monitored for leak detection, the source from which the data stream is obtained, and the like. For example, if the asset is being monitored by a leak detection sensor and a GCI camera, the pre-defined set of leak attributes may include a leak rate—from the leak detection sensor and a flag status—from the GCI camera. In this case, both the leak rate and flag status serve as indicators of potential leaks, each derived from its respective monitoring device. Identifying and isolating these key leak attributes focuses on the most relevant data for leak detection. This approach enhances the efficiency of processing incoming data streams, leading to more accurate potential leak detection. Additionally, it reduces the computational resources required for processing large amounts of data. Such targeted data selection allows for quick and instantaneous identification of potential leak events across various types of assets and monitoring configurations.

To detect instantaneous leaks across the facility, on identifying the first set of data streams, one or more leak attributes from the first set of data streams may be identified. This technique may involve selecting specific leak attributes from the identified data streams for focused monitoring. For instance, if the system has identified data streams from leak detection sensors and GCI cameras as relevant, it may then select leak rate from the sensor data and flag status from the camera data as the key attributes to monitor. By isolating these particular leak attributes, the system may streamline its monitoring process, allowing for more efficient and targeted leak detection. In one example, the one or more leak attributes may be detected from the data stream. In another example, the one or more leak attributes may be computed from the leak attributes detected in the data stream. That is, for example, a leak attribute such as leak rate may be detected in the data stream associated with a leak detection sensor. Alternatively, the leak rate may be calculated from another leak attribute.

In one example, the one or more leak attributes identified may be ordered in correspondence to a time of detection of each leak attribute. Further, in one example, the ordered leak attributes may be grouped in correspondence to the type of sensing mode. For example, all leak attributes associated with leak detection sensors may be grouped into a first cluster. Similarly, all leak attributes associated with a GCI camera may be grouped into a second cluster, and all attributes associated with a drone may be grouped into a third cluster, and the like. Ordering and grouping of the leak detection attributes based on their time of detection provides an insight into how the leak may be developing and progressing. For instance, in an oil refinery, a series of related leak attributes may be detected. First, a slight increase in hydrocarbon vapors from an optical gas imaging camera, followed by a temperature change in a nearby pipe, and finally, a pressure drop in the system. By ordering and grouping these attributes, development of the leak over time and across different parts of the refinery may be analyzed.

Further, the first set of data streams are monitored in real-time to identify a change in value of the at least one leak attribute that is identified. The change in value of the at least one leak attribute may then be analyzed to determine presence of a leak of the compound. In one example, each leak attribute may be associated with a pre-determined rule, based on which the change in value of the leak attribute may be analyzed. The pre-determined rules may be based on the type of compound being monitored, a type of asset, a location of the facility, a type of the facility, an amount of leak quantity, the rate of occurrence of the leak, an area of occurrence of the leak, and the like. For instance, for the leak attribute such as a leak rate, the presence of the leak may be determined when the leak rate changes from zero to a non-zero value. Alternatively, the change in value of the leak rate from a non-zero value to zero may be indicative of a leak closure or may be identified as Return to Normal (RTN). Similarly, while monitoring a leak attribute corresponding to a GCI camera, on the occurrence of an event, for example on the onset of a leak, a status of the flag may change from zero to 1 indicating the onset of the leak, and the like.

In one example, the change in value of the leak attribute may be analyzed over a predetermined time period, for example, over 5 minutes, or 10 minutes, and the like, and when the change in value of the leak attribute persists for the predetermined time period, the presence of a leak may be determined. For instance, a methane sensor near a natural gas pipeline may continuously monitor concentration levels in real-time, and may report readings every minute, starting at 2 ppm and gradually increasing to 12 ppm over a five-minute period. In one example, the predetermined rule for determining a leak may be that if methane concentration remains above 5 ppm for 5 consecutive minutes, then the presence of a leak may be flagged. In the current example, as the elevated methane levels persist for the predetermined 5-minute period, the system 106 may determine the presence of a leak at the 5-minute mark. Analyzing the change in value of the leak attribute over a predetermined time period allows for detection of slow and steadily increasing concentrations of a compound which may indicate a small but persistent leak. In one example, the predetermined time period may be set based on the type of compound being monitored.

In another example, the change in value of the leak attribute may be monitored for a specified time period, and when the change in value of the leak attribute crosses a predetermined threshold value within the specified time period, the presence of the leak may be determined. For instance, a pressure sensor on an ammonia refrigeration system may report pressure readings every 10 seconds. The pressure starts at 250 psi and rapidly decreases to 225 psi over a 50-second period. In one example, the predetermined rule for determining a leak may be that if pressure drops by more than 20 psi within a 1-minute period, the presence of a leak may be determined. Analyzing the change in value of the leak attribute based on the predetermined threshold value allows for quick response to sudden, significant changes in monitored parameters that may indicate a rapid leak. In one example, the predetermined threshold value may be adaptive and may be dynamically updated based on historical data and operational patterns of the asset.

In yet another example, the change in value of the leak attribute may be analyzed in conjunction with values of other leak attributes from the pre-defined set of leak attributes to determine presence of a leak of the compound. That is, on detecting a change in value of a first leak attribute out of multiple leak attributes, the system may also analyze one or more other leak attributes along with the change in value of the first leak attribute to determine the presence of a leak. This allows for accurate leak detection, by preempting false leak detections. For example, an oil storage tank is monitored by multiple sensors, including a level sensor, a hydrocarbon vapor detector, a flow meter, and the like. Over a 2-hour period, the level sensor may show a slight decrease from 80% to 79.5% full, which alone might not trigger an alert. However, the hydrocarbon vapor detector may simultaneously record an increase in vapor concentration from 50 ppm to 150 ppm, while the flow meter confirms no input flow during this period. By analyzing these multiple leak attributes in conjunction, the system may determine the presence of a leak. Therefore, analyzing and correlating data from multiple sources to detect leaks that might not be apparent from a single sensor's data, reduce false positives and also increase the detection accuracy.

Further, in one example, the pre-determined rules may include correlation rules that assess patterns across multiple sensors or assets to help identify complex leak scenarios that might not be apparent from a single data source, such as a small leak that affects multiple nearby sensors in subtle ways. Additionally, the predetermined rules may incorporate environmental factors such as temperature, pressure, humidity, and wind conditions, which can significantly affect leak behavior and detection accuracy, and the like. For instance, a rule may be set to adjust the leak rate thresholds based on ambient temperature, as some compounds become more volatile in higher temperatures, and the like. In one example, the predetermined rules may also be defined based on the age of the asset, maintenance history, known wear patterns of specific assets, and the like, allowing for more accurate leak prediction and detection as the asset ages.

Further, the pre-determined rules may be dynamically updated, refined, and optimized for accurate leak detection. In one example, the leak detection module 312 may include a rule engine (not depicted in the figure) configured to store and implement the pre-determined rules. In one example, the rule engine may be trained using machine learning algorithms. The rule engine may be dynamically updated to refine and optimize the pre-determined rules for more accurate leak detection, thereby allowing the system to adapt to changing conditions and improving its performance over time based on new data and insights. The rule engine may incorporate feedback from leak detection results, maintenance records, and environmental data to continuously enhance its rule set. For instance, it may adjust detection thresholds based on seasonal variations or equipment aging patterns. The rule engine may also learn from false positives and false negatives to improve its accuracy over time, thereby ensuring that the leak detection system remains effective and efficient even as facility conditions evolve. In one example, the rule engine may be periodically updated by personnel of the facility, or an end-user, and the like, making them flexible and adaptable to specific conditions and challenges of each facility.

On determining the presence of a leak, in one example, a data stream associated with the leak attribute may be identified. Based on this identification, sensing elements amongst the multiple sensing elements associated with said data stream may be traced for localization of the leak source. In one example, on tracing the sensing elements, the contextualizing module 314 may contextualize the leak. For example, an asset associated with the traced sensing elements may be identified. A location of the asset within the facility may be determined, and the leak may be associated with the identified asset and its location. Contextualizing the leak with the asset allows for rapid response and targeted maintenance actions. In one example, the contextualization process may also include providing historical data associated with similar leaks for the asset or similar assets to help a user understand historical patterns associated with the said leak, or asset, to plan mitigative actions appropriately.

Further, contextualizing the leak may include associating the leak with at least one of a leak ID, location of the leak, a leak start time, a leak end time, a leak area, a leak gas type, a leak rate, and the like. The following example of contextualization of the leak is only to elucidate the principles of the present subject matter and is not to be construed as a limitation. For instance, in a petrochemical facility, the system 106 may identify a potential leak based on a sensor ‘X’ near a storage tank, for example, Tank—A45. In one example, this potential leak may be identified at 2:15 pm on Mar. 20, 2024. The leak may be contextualized as a leak having Leak ID: LK-20240320-001, the Asset associated with leak may be identified as—storage Tank—A45, a location of the leak may be identified as: North-west corner of the facility, coordinates: 45.3721° N, 75.6851° W. Similarly, the following details may be generated: Leak start time: 2024-03-20 14:15:00, Leak Gas Type: Methane, Initial Leak Rate: 0.5 kg/hour, Leak Area: Approximately 2 square meters around the tank's base seal, and the like. This contextualized information with the leak event provides a comprehensive snapshot of the incident, allowing facility operators to quickly understand the nature and location of the leak, facilitating rapid response and targeted mitigation efforts. The leak ID enables tracking of the event throughout its lifecycle, while the precise location and asset information may guide maintenance teams directly to the affected area. The leak start time, gas type, and rate information help in assessing the severity and potential impact of the leak, facilitating personnel of the facility to take informed decisions.

Additionally, in one example, an impact associated with the leak may also be determined to prioritize mitigative actions. For example, the leaks detected in a facility, or across multiple facilities may be ranked based on an impact associated with them for prioritization of the leak. In one example, the impact associated with the leak may be determined based on factors, such as severity of the leak, leak rate, compound toxicity, proximity to sensitive areas, and the like. In one example, environmental conditions, such as temperature, pressure, wind direction, and the like, may also be considered to facilitate analyzing the behavior of the leak and its potential impact on the surrounding environment. Leaks may be prioritized based on a duration of the leak, where longer-lasting leaks may be given higher priority due to their cumulative impact, or a location of the leak, where leaks in critical areas or near high-value assets may be prioritized, or a regulatory impact, where leaks that could lead to compliance issues are flagged for immediate attention, or safety risk, where leaks posing immediate danger to personnel or equipment are given top priority, or the like. Such prioritization may facilitate operators in focusing on the most critical leak events first, optimizing resource allocation and response times.

Further, on contextualizing the leak, in one example, leak metrics associated with the leak may be calculated. For example, instantaneous leak rate, cumulative leaked volume, environmental impact expressed in CO2 equivalents, and the like. In one example, the leak rate may be calculated based on the change in value of the at least one leak attribute. Further, a quantity of the compound leaked may be estimated based on the leak rate and a duration of the leak. Additionally, an estimate of potential financial losses due to product loss and regulatory fines may also be determined. In one example, an assessment report may be generated, inclusive of these metrics may be presented to a user.

In one example, the contextualized leak may be provided to a user interface. The interface may present the data in various formats, such as interactive maps, time-series graphs, and detailed reports. This allows facility operators, maintenance teams, and management to quickly assess the situation, make informed decisions, and initiate appropriate response actions. For instance, the dashboard may display a flashing red indicator for a high-volume leak exceeding 5 kg/hr, along with a projection of environmental impact if left unaddressed for 24 hours, and the like.

Additionally, in one example, the contextualized leak information may be used to trigger automated workflows. In one example, the pre-determined rules may include rules associated with workflows or mitigative actions that may be carried out on the occurrence of a leak. For example, based on the leak's severity, location, and gas type, the system may automatically generate work orders, send notifications to relevant personnel, or activate emergency response protocols if necessary. The contextualized leak may also include life cycle data associated with the leak from detection to final resolution, which is updated in real-time.

Therefore, techniques of the present subject matter facilitate real-time instantaneous leak detection across multiple assets and facilities. By leveraging diverse sensing modes and data streams, these techniques can quickly identify, contextualize, and respond to leaks. They enable comprehensive monitoring, accurate detection, and prioritized mitigation of leaks, enhancing operational efficiency, safety, and environmental compliance. The integration of automated workflows and dynamic rule engines further streamlines the leak management process, allowing for rapid response and continuous improvement in leak detection and mitigation strategies.

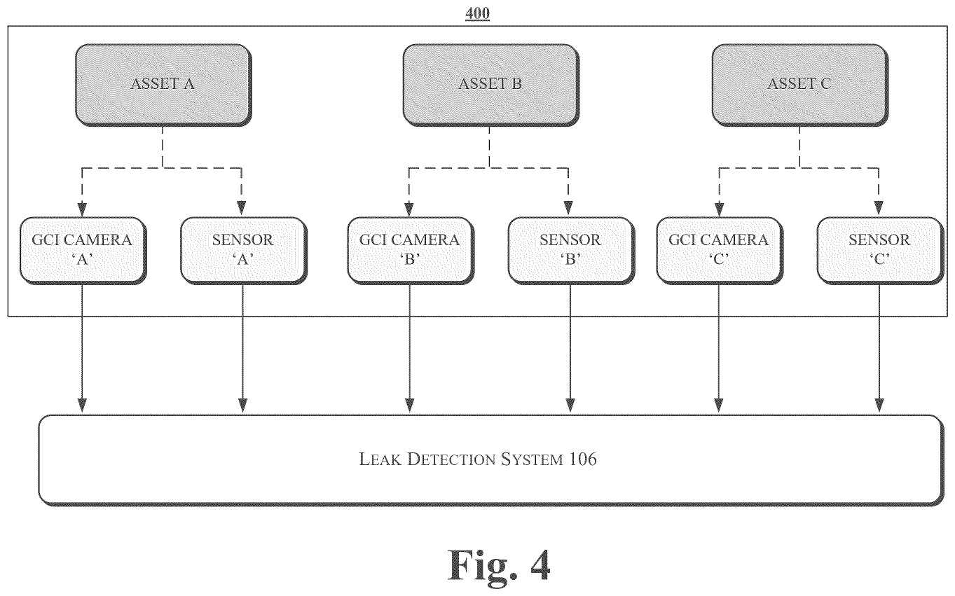

FIG. 4 illustrates a schematic for leak detection of a compound associated with an asset of the facility, in accordance with an example of the present subject matter. The following example of leak detection is only to elucidate the principles of the present subject matter and is not to be construed as a limitation. In one example, the facility may be a biogas production facility 400 which includes three assets, namely Asset ‘A’, Asset ‘B’ and Asset ‘C’ which handle methane, amongst multiple other assets. The three assets may be located in close proximity to one another. Each asset may be equipped with multiple sensing elements, including Gas Concentration Imaging (GCI) cameras and methane-specific leak detection sensors. In one example, data streams from these sensing elements may be received continuously in real-time. These data streams may include leak attributes to identify potential leaks of methane. In one example, these leak attributes may include gas concentration, pressure changes, temperature variations, flow rate anomalies, and spatial data from GCI cameras. In one example, the leak detection system 106 may continuously monitor and analyse these data streams in real-time to detect and characterize potential methane leaks.

The data streams from both the GCI cameras and the methane sensors may be monitored in real-time to identify changes in the leak attributes associated with all the three assets. These changes in the leak attributes may be analysed continuously across all three assets. When a leak attribute, such as methane concentration or pressure, exceeds a predetermined threshold value in any of the monitored data streams, it may be determined as the onset of a methane leak in the area. For instance, if the methane concentration near Asset ‘B’ changes from a baseline level of 2 ppm to 10 ppm and continues to increase over a 5-minute period, it may indicate a developing leak.

When a leak attribute exceeds the predetermined threshold value, as described in the example above, the leak detection system 106 may analyse the data streams from each asset's sensors individually, comparing leak attribute values, and examining the spatial data from the GCI cameras. The data stream in which the change in the leak attribute was first noticed may be identified to trace the sensing elements from which the said data stream was received. For example, if Asset ‘B’ shows the highest methane concentration or the most significant change in pressure compared to Assets ‘A’ and ‘C’, its corresponding data stream may be identified as the source of the leak indication. The system 106 may then trace this data stream back to the specific sensing elements or sensors associated with Asset ‘B’, potentially pinpointing the exact location or component responsible for the leak. The methane leak may then be contextualized based on the traced sensing elements, pinpointing its location on Asset ‘B’, associating it with Asset ‘B’s specific ID, and determining its proximity to Assets ‘A’ and ‘C’ within the biogas production facility. The methane leak determined, may also be associated with a Leak ID. Further, one or more leak metrics associated with the current methane leak may be calculated in real time, specifically for Asset ‘B’. This may include determining the leak rate (e.g., 5 kg/hour), duration (e.g., 30 minutes), and total volume of methane released (e.g., 2.5 kg). Based on these metrics, in one example, the leak detection system 106 may convert various types of compound leaks into standardized CO2 equivalent emissions. For example, when dealing with methane (CH4) leaks, the system may convert the leaked amount to its CO2 equivalent. Similarly, for nitrous oxide (N2O) leaks, the system may apply an appropriate factor for N2O to calculate the CO2 equivalent, and the like. This allows for consistent comparison and reporting of environmental impact across different types of compound leaks.

Continuing with the description of FIG. 4, in one example, the emission data computed may be checked against regulatory requirements to determine if the leak from Asset ‘B’ exceeds permissible limits for the biogas production facility. In one example, the conversion factors used may be periodically updated to align with the latest regulatory standards. Further, the contextualized methane leak, now associated with Asset ‘B’, may be further analysed based on a set of pre-determined rules to determine the urgency of the required response. For instance, if the leak meets certain criteria, such as exceeding specific emission rates or regulatory thresholds, appropriate notifications may be issued to relevant personnel of the biogas production facility, clearly indicating that Asset ‘B’ requires attention and what mitigative measures should be taken. Based on this analysis, recommended mitigative actions to contain the methane leak within allowable values may be generated, tailored specifically to Asset ‘B’. These recommendations may be provided to plant personnel for immediate action on Asset ‘B’.

Therefore, techniques of the present subject matter allow for real-time monitoring of Assets ‘A’, ‘B’, and ‘C’ in close proximity within the biogas production facility, quick identification of leaks, accurate determination of which asset is responsible for the leak, immediate contextualization, and rapid response. It may prevent significant methane release by pinpointing the exact source among the three closely spaced assets, ensuring regulatory compliance, and enabling swift implementation of mitigative measures and to curtail product loss.

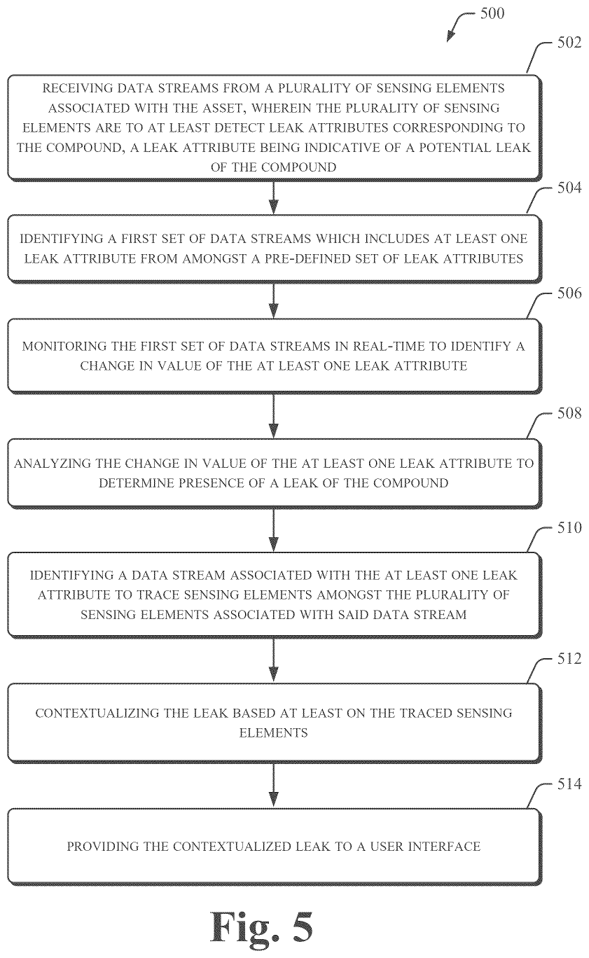

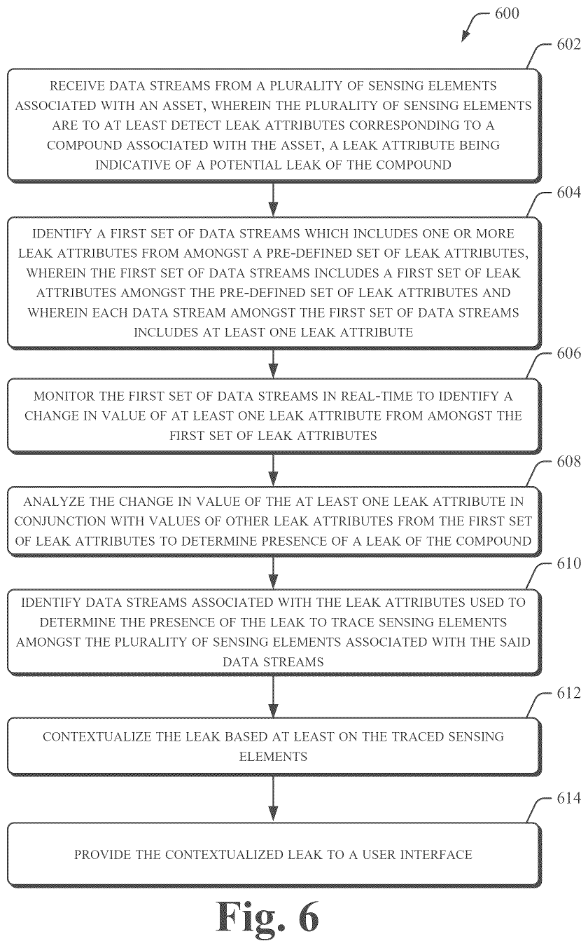

FIGS. 5 and 6 illustrate methods 500 and 600 for leak detection of a compound associated with an asset, in accordance with examples of the present subject matter. The order in which the methods are described is not intended to be construed as a limitation, and any number of the described method blocks may be combined in any order to implement the methods, or an alternative method. Further, the methods 500 and 600 may be implemented by processing resource or computing device(s) through any suitable hardware, non-transitory machine-readable instructions, or combination thereof.

It may also be understood that methods 500 and 600 may be performed by programmed computing devices, such as the leak detection system 106, as depicted in FIG. 3. Furthermore, the methods 500 and 600 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. The methods 500 and 600 are described below with reference to the leak detection system 106, as described above; other suitable systems for the execution of these methods may also be utilized. Additionally, implementation of the method is not limited to such examples.

FIG. 5 illustrates an example method for leak detection of a compound associated with an asset, in accordance with an example of the present subject matter. In FIG. 5, at block 502, the method 500 includes receiving data streams from a plurality of sensing elements associated with the asset, where the plurality of sensing elements are to at least detect leak attributes corresponding to the compound, a leak attribute being indicative of a potential leak of the compound.

At block 504, the method 500 includes identifying a first set of data streams which includes at least one leak attribute from amongst a pre-defined set of leak attributes. The pre-defined set of leak attributes may include attributes that are indicative of a potential leak of the compound being monitored. The pre-defined set of leak attributes would vary based on, for example but not limited to, the type of asset being monitored, the type of compound being monitored for leak detection, the source from which the data stream is obtained, and the like.

In one example, a plurality of leak attributes from amongst the pre-defined set of leak attributes may be identified, where the plurality of leak attributes includes the at least one leak attributes. The plurality of leak attributes may be ordered in correspondence to a time of detection for each leak attribute. Further, in one example, the ordered plurality of leak attributes may be grouped in correspondence to a type of sensing mode. Where each sensing mode may be associated with one or more sensing elements amongst the plurality of sensing elements from which data streams including the leak attributes originate. Ordering and grouping of the leak detection attributes based on their time of detection provides an insight into how the leak may be developing and progressing.

At block 506, the method 500 includes monitoring the first set of data streams in real-time to identify a change in value of the at least one leak attribute.

At block 508, the method 500 includes analyzing the change in value of the at least one leak attribute to determine presence of a leak of the compound. In one example, the change in value of the at least one leak attribute may be analyzed based on a set of pre-determined rules. Each leak attribute may be analyzed using different pre-determined rules to assess the start of a leak. In one example, the pre-determined rules may be based on the type of sensing mode. The set of pre-determined rules may also be based on the type of compound being monitored, a type of asset, a location of the facility, a type of the facility, an amount of leak quantity, the rate of occurrence of the leak, an area of occurrence of the leak, and the like. In one example, the change in value of the at least one leak attribute may include comparing the change in value of the at least one leak attribute with a set of pre-determined rules to determine presence of the leak of the compound.

At block 510, the method 500 includes identifying a data stream associated with the at least one leak attribute to trace sensing elements amongst the plurality of sensing elements associated with said data stream.

At block 512, the method 500 includes contextualizing the leak based at least on the traced sensing elements. In one example, contextualizing the leak includes associating the leak with at least one of a leak ID, location of the leak, a leak start time, a leak end time, a leak area, a leak gas type, and a leak rate. In one example, an asset associated with the traced sensing elements may be identified, a location of the asset within a facility may be determined and the leak may be associated with the identified asset and its location. In one example, the contextualized leak may be converted into leak emission data by calculating an equivalent amount of greenhouse gas emissions based on characteristics of the compound and the contextualized leak.

At block 514, the method 500 includes providing the contextualized leak to a user interface. In one example, the user interface may display the contextualized leak. Additionally, in one example, a work order based on the contextualized leak may be generated. Further, the work order may assigned to a maintenance personnel for leak remediation. In one example, a status of the work order may be tracked and presented on the user interface in real-time until the leak is resolved.

FIG. 6 illustrates another example method for leak detection of a compound associated with an asset, in accordance with an example of the present subject matter. In FIG. 6, the method 600 at block 602 includes receiving data streams from a plurality of sensing elements associated with an asset, where the plurality of sensing elements are to at least detect leak attributes corresponding to a compound associated with the asset, a leak attribute being indicative of a potential leak of the compound. For instance, a natural gas storage facility may have multiple sensing elements deployed. These sensing elements may include methane sensors to detect gas concentration, pressure sensors to monitor tank pressure, and infrared cameras to visualize potential gas leaks. Each of these sensing elements may provide a continuous stream of data related to potential leak attributes.

At block 604, the method 600 includes identifying a first set of data streams which includes one or more leak attributes from amongst a pre-defined set of leak attributes. This pre-defined set of leak attributes may encompass various parameters indicative of potential leaks. Further, the first set of data streams may include a first set of leak attributes amongst the pre-defined set of leak attributes. That is, if the pre-defined set of leak attributes include 10 different leak attributes that can be monitored, in an example, the first set of leak attributes may include 4 leak attributes from amongst the 10 leak attributes identified. In one example, the first set of leak attributes may be determined based on the compound that is being monitored, the type of asset being monitored, the type of attribute—for example, some leak attributes may indicate a presence of a leak faster than other leak attributes, and the like. In one example, each data stream amongst the first set of data streams may include at least one leak attribute. In the example of the natural gas storage facility, the pre-defined set of leak attributes may include methane concentration, pressure changes, and thermal anomalies and the first set of leak attributes may include methane concentration and pressure changes as relevant leak attributes. Accordingly, data streams from the methane sensors and the pressure sensors may be identified as the first set of data streams as they contain relevant leak attributes.

At block 606, the method 600 includes monitoring the first set of data streams in real-time to identify a change in value of at least one leak attribute from amongst the first set of leak attributes. For example, the data streams which include methane concentration as one of the attributes and pressure data as one of the attributes, may be monitored continuously in real-time.

At block 608, the method 600 includes analyzing the change in value of the at least one leak attribute in conjunction with values of other leak attributes from the first set of leak attributes to determine presence of a leak of the compound. In one example, the change in values of leak attributes may be analyzed based on pre-determined rules. These pre-determined rules may be based on various aspects, such as the type of compound being monitored, a type of asset, a location of the facility, a type of the facility, an amount of leak quantity, the rate of occurrence of the leak, an area of occurrence of the leak, correlation rules between multiple leak attributes for an asset, correlation rules between multiple leak attributes from similar assets, and the like. In the example as described above, the methane sensor may detect an increase in concentration from 2 ppm to 10 ppm, and simultaneously, the pressure sensor may detect a slight pressure drop in the storage tank, these changes in multiple leak attributes may be analyzed together to determine if a leak is present.

At block 610, the method 600 includes identifying data streams associated with the leak attributes used to determine the presence of the leak to trace sensing elements amongst the plurality of sensing elements associated with the said data streams. For example, upon determining a potential leak, the method may identify that the relevant data streams came from a specific methane sensor and pressure sensor near Storage Tank A.

At block 612, the method 600 includes contextualizing the leak based at least on the traced sensing elements. In the current example of the natural gas storage facility, the leak may be contextualized by associating it with Storage Tank A, its location within the facility, the time of detection, and the specific sensors that detected it.

At block 614, the method 600 includes providing the contextualized leak to a user interface. The user interface may display an alert showing a potential methane leak at Storage Tank A, detected at a specific time, with details on the methane concentration and pressure changes that led to the leak determination.

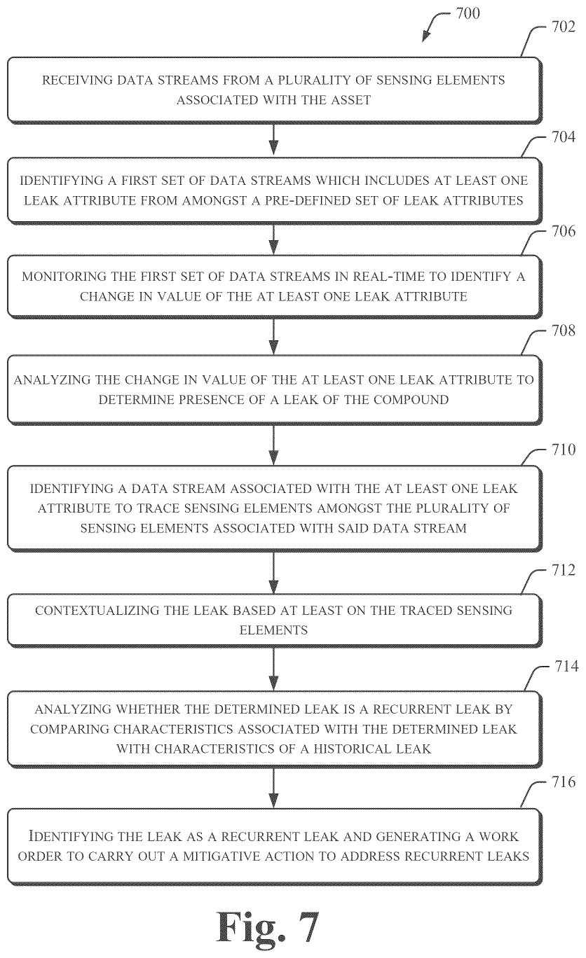

FIGS. 7, 8, and 9 illustrate methods 700, 800, and 900 for leak detection of a compound associated with an asset, in accordance with examples of the present subject matter. The order in which the methods are described is not intended to be construed as a limitation, and any number of the described method blocks may be combined in any order to implement the methods, or an alternative method. Further, the methods 700, 800, and 900 may be implemented by processing resource or computing device(s) through any suitable hardware, non-transitory machine-readable instructions, or combination thereof.

It may also be understood that methods 700, 800, and 900 may be performed by programmed computing devices, such as the leak detection system 106, as depicted in FIG. 3. Furthermore, the methods 700, 800, and 900 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. The methods 700, 800, and 900 are described below with reference to the leak detection system 106, as described above; other suitable systems for the execution of these methods may also be utilized. Additionally, implementation of the method is not limited to such examples.

FIG. 7 illustrates an example method for identifying a recurring leak, in accordance with an example implementation of the present subject matter. At block 702, the method 700 includes receiving data streams from a plurality of sensing elements associated with an asset, where the plurality of sensing elements are to at least detect leak attributes corresponding to the compound, a leak attribute being indicative of a potential leak of the compound. For instance, multiple data streams from various sensing elements deployed pipelines and storage tanks across a chemical processing plant may be obtained. These sensing elements may include, for example, chemical vapor detectors, pressure sensors, and flow meters, each providing continuous data streams related to potential leak attributes.

At block 704, the method 700 includes identifying a first set of data streams which includes at least one leak attribute from amongst a pre-defined set of leak attributes. In the above example, a first set of data streams received from chemical vapor detectors and pressure sensors that contain relevant leak attributes such as chemical concentration and pressure fluctuations may be identified.

At block 706, the method 700 includes monitoring the first set of data streams in real-time to identify a change in value of the at least one leak attribute. For example, the chemical vapor concentration and pressure data may be continuously monitored in real-time.

At block 708, the method 700 includes analyzing the change in value of the at least one leak attribute to determine presence of a leak of the compound. In one example, the change in value of the at least one leak attribute may be analyzed based on a set of pre-determined rules associated with the said leak attribute. The pre-determined rules may be based on the type of compound being monitored, a type of asset, a location of the facility, a type of the facility, an amount of leak quantity, the rate of occurrence of the leak, an area of occurrence of the leak, and the like. For instance, in the current example of the chemical processing plant, when the concentration of chemical compound increases from 1 ppm to 5 ppm, an onset of the leak may be determined.

At block 710, the method 700 includes identifying a data stream associated with the at least one leak attribute to trace sensing elements amongst the plurality of sensing elements associated with said data stream.

At block 712, the method 700 includes contextualizing the leak based at least on the traced sensing elements. Upon determining an onset of the leak, it may be identified that the relevant data stream came from a specific chemical vapor detector near Pipeline B. Accordingly, the leak may be contextualized by associating it with Pipeline B, its location within the facility, the time of detection, and the specific sensor that detected it.

At block 714, the method 700 includes analyzing whether the determined leak is a recurrent leak by comparing characteristics associated with the determined leak with characteristics of a historical leak. For example, the characteristics of the current leak, such as location, compound type, leak rate, environmental conditions, and associated equipment may be analysed. These characteristics may then be compared to characteristics of historical leaks which allow identification of complex patterns and similarities that may indicate recurrence, even if the leaks are not identical. In another example, a frequency-based determination may be utilized to identify a recurrent leak, where a leak is classified as recurrent if it has occurred more than a pre-determined number of times.

At block 716, the method 700 includes identifying the leak as a recurrent leak and generating a work order to carry out a mitigative action to address recurrent leaks. For instance, if a leak at Pipeline B has been detected more than three times in the past month, the current leak which is determined may be flagged as a recurrent leak. On determining that the current leak of the chemical compound is a recurrent leak, a work order may be automatically generated to inspect and repair Pipeline B, addressing the root cause of these recurrent leaks. In one example, the contextualized leak data may be updated in real-time, indicating that the current leak that is determined is a recurrent leak, and data associated with historical leaks associated with the asset, remedial actions carried out in the past to address historical leaks, and the like, may be provided to a user.

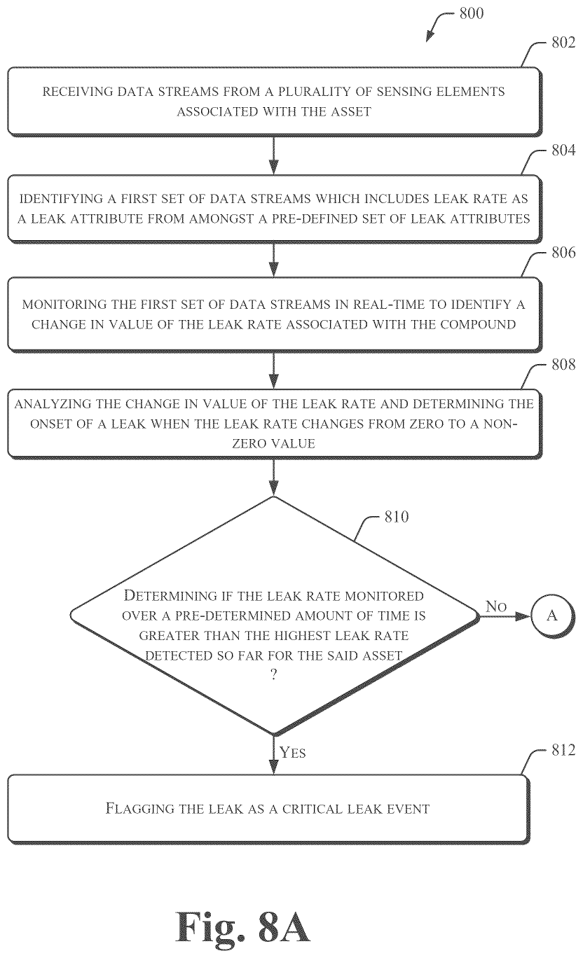

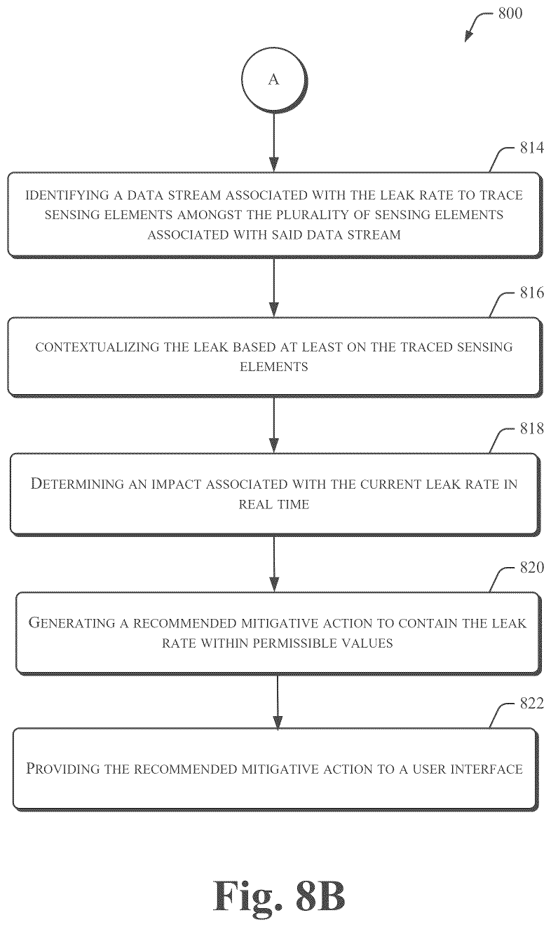

FIG. 8A illustrates another example method for leak detection of a compound associated with an asset, in accordance with an example implementation of the present subject matter. In FIG. 8A, at block 802, the method 800 includes receiving data streams from a plurality of sensing elements associated with the asset. For example, in a facility such as a natural gas processing facility, these sensing elements may include flow meters, pressure sensors, and gas detectors placed strategically throughout the pipeline network and processing units.

At block 804, the method 800 includes identifying a first set of data streams which includes leak rate as a leak attribute from amongst a pre-defined set of leak attributes. In one example, the pre-defined set of leak attributes may include various parameters indicative of potential leaks. Identifying and focusing on a specific set of data streams with relevant leak attributes can substantially reduce the computational resources required for leak detection. In one example, the incoming data streams may be filtered to focus on those that specifically provide leak rate information. For instance, the method may identify data streams from ultrasonic flow meters that can detect changes in gas flow rates indicative of leaks.

At block 806, the method 800 includes monitoring the first set of data streams in real-time to identify a change in value of the leak rate associated with the compound. This involves continuous, real-time analysis of the identified data streams to detect any variations in leak rate. For example, a flow meter's data stream may be monitored, looking for unexpected changes in gas flow rates that could indicate a leak.

At block 808, the method 800 includes analysing the change in value of the leak rate and determining the onset of a leak when the leak rate changes from zero to a non-zero value. For instance, if a flow meter in a normally closed section of pipeline suddenly registers a non-zero flow rate, this may be interpreted as the onset of a leak.

At block 810, the method 800 includes determining if the leak rate monitored over a pre-determined amount of time is greater than the highest leak rate detected so far for the said asset. In one example, the pre-determined amount of time may be determined based on a type of the asset, toxicity of the compound, type of compound, cost of compound, and the like. In one example, if it is determined that the leak rate monitored over a pre-determined amount of time is greater than the highest leak rate detected so far for the said asset, at block 812, the method 800 includes flagging the leak as a critical leak event. In one example, on identifying a critical leak event, personnel associated with the facility may be notified in real-time. In one example, a progression of the leak may also be provided to the user in real-time to prevent any adverse effects that could be associated with the leak. For example, if a newly detected leak rate of 50 liters per minute exceeds the previous highest recorded leak rate of 30 liters per minute for that particular pipeline section, it may be flagged as a critical leak event. In one example, when a leak is flagged as a critical leak event, the system may automatically generate and send email notifications to a predefined list of recipients, such as facility managers, safety officers, and relevant maintenance personnel. These email notifications may include details about the critical leak event, such as its location, severity, and recommended immediate actions.

In one example, if it is determined that the leak rate monitored over a pre-determined amount of time is not greater than the highest leak rate detected so far for the said asset, the method 800 proceeds as depicted in FIG. 8B. FIG. 8B illustrates a continuation of the method in FIG. 8A for leak detection of a compound associated with an asset. In FIG. 8B, at block 814, the method 800 includes identifying a data stream associated with the leak rate to trace sensing elements amongst the plurality of sensing elements associated with said data stream. This step involves pinpointing the exact sensor(s) detecting the leak. For instance, if a leak is detected, the system may identify that the data stream comes from flow meter FM-101 located on pipeline section P-203.

At block 816, the method 800 includes contextualizing the leak based at least on the traced sensing elements. For example, the leak detected by flow meter FM-101 may be contextualized as occurring in the north-west section of the facility, on a high-pressure natural gas line, at coordinates 41°24′12.2″N 2°10′26.5″E.

At block 818, the method 800 includes determining an impact associated with the current leak rate in real time. This step assesses the potential consequences of the leak. For instance, based on the current leak rate of 50 liters per minute, the system may calculate that this equates to a loss of 72,000 liters of natural gas per day, with associated financial and environmental impacts.

At block 820, the method 800 includes generating a recommended mitigative action to contain the leak rate within permissible values. Based on the leak's characteristics and impact, appropriate actions may be recommended. For example, immediate isolation of pipeline section P-203 and dispatch of an emergency repair team may be recommended.

At block 822, the method 800 includes providing the recommended mitigative action to a user interface. This final step involves communicating the leak information and recommended actions to relevant personnel. For instance, an alert may be sent to the control room operator's dashboard, detailing the leak location, severity, impact, and recommended actions, enabling quick and informed decision-making.

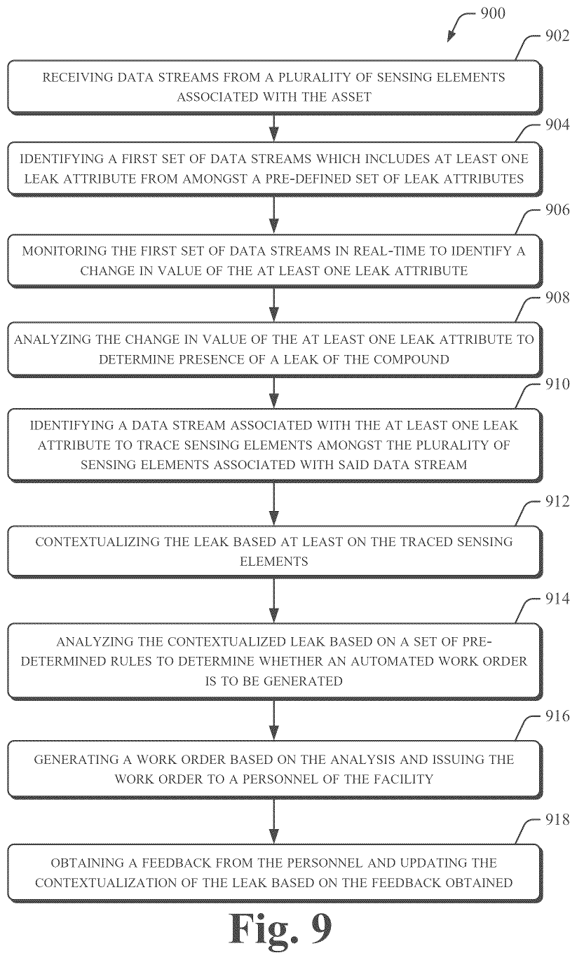

FIG. 9. illustrates another example method 900 for leak detection of a compound, in accordance with an example of the present subject matter. In FIG. 9, at block 902, the method 900 includes receiving data streams from a plurality of sensing elements associated with the asset, where the plurality of sensing elements are to at least detect leak attributes corresponding to the compound, a leak attribute being indicative of a potential leak of the compound. This step involves collecting real-time data from various sensors deployed across the asset. For example, in a petrochemical plant, these sensing elements may include gas detectors, pressure sensors, and thermal imaging cameras positioned throughout the facility to monitor for potential leaks of volatile organic compounds (VOCs).

At block 904, the method 900 includes identifying a first set of data streams which includes at least one leak attribute from amongst a pre-defined set of leak attributes. This step involves filtering the incoming data streams to focus on those that provide relevant leak information. For instance, the method may identify data streams from VOC sensors that detect changes in gas concentration and thermal imaging cameras that can detect temperature anomalies indicative of leaks.

At block 906, the method 900 includes monitoring the first set of data streams in real-time to identify a change in value of the at least one leak attribute. This involves continuous, real-time analysis of the identified data streams to detect any variations in leak attributes. For example, the system may monitor a VOC sensor's data stream, looking for sudden increases in gas concentration that could indicate a leak.

At block 908, the method 900 includes analyzing the change in value of the at least one leak attribute to determine presence of a leak of the compound. This step establishes the criteria for leak detection. In one example, determination of the presence of a leak may be based on a set of pre-determined rules. These pre-determined rules may be based on the type of compound being monitored, a type of asset, a location of the facility, a type of the facility, an amount of leak quantity, the rate of occurrence of the leak, an area of occurrence of the leak, and the like For instance, if a VOC sensor detects a concentration increase from 5 ppm to 50 ppm within a short time frame, this may be interpreted as the presence of a leak.

At block 910, the method 900 includes identifying a data stream associated with the at least one leak attribute to trace sensing elements amongst the plurality of sensing elements associated with said data stream. This step involves pinpointing the exact sensor(s) detecting the leak. For example, if a leak is detected, the system may identify that the data stream comes from VOC sensor VS-301 located near storage tank ST-105.

At block 912, the method 900 includes contextualizing the leak based at least on the traced sensing elements. This step involves associating the leak with specific asset information. For example, the leak detected by VOC sensor VS-301 may be contextualized as occurring in the eastern section of the facility, near a benzene storage tank, at coordinates 29°45′30.5″N 95°21′37.2″W.

At block 914, the method 900 includes analysing the contextualized leak based on a set of pre-determined rules to determine whether an automated work order is to be generated. This step evaluates the leak against established criteria to decide on further actions. For instance, if the detected benzene concentration exceeds 20 ppm for more than 15 minutes, it may trigger the generation of an automated work order.

At block 916, the method 900 includes generating a work order based on the analysis and issuing the work order to a personnel of the facility. Based on the analysis in the previous step, an automated work order may be created and assigned. For example, a work order may be generated for the maintenance team to inspect and repair potential leak sources around storage tank ST-105, with priority set to high due to the hazardous nature of benzene.

At block 918, the method 900 includes obtaining a feedback from the personnel and updating the contextualization of the leak based on the feedback obtained. This final step involves incorporating feedback in real-time into the leak management process. For instance, after inspecting the area, the maintenance team may provide feedback that the leak was caused by a faulty valve gasket on tank ST-105. This information is then used to update the leak contextualization, including details about the specific component that failed, and the like, which can inform future maintenance schedules and leak prevention strategies.

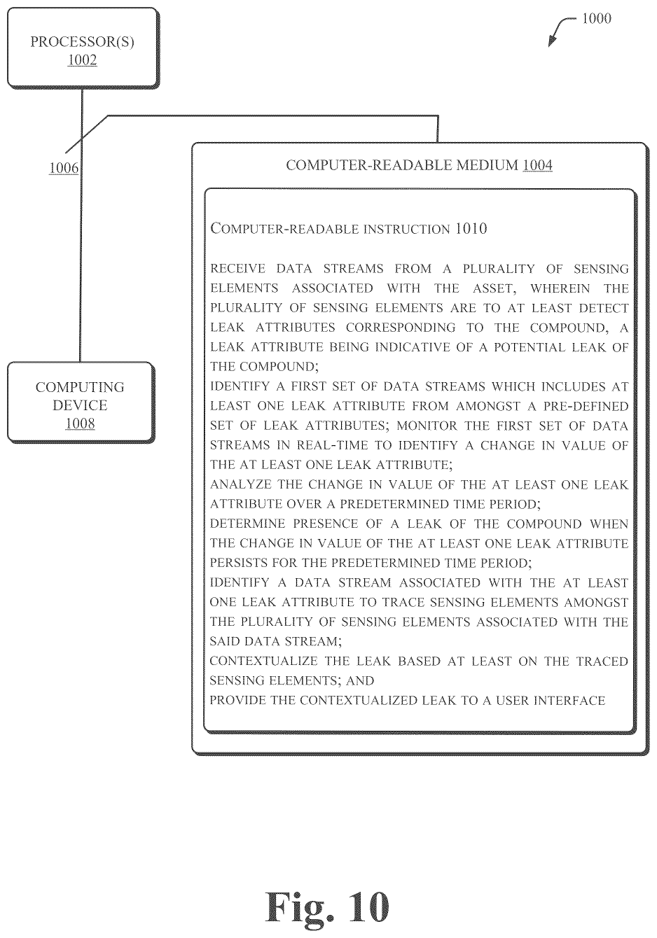

FIG. 10 illustrates a non-transitory computer-readable medium for leak detection of a compound associated with an asset, in accordance with an example of the present subject matter. In an example, the computing environment 1000 includes processor 1002 communicatively coupled to a non-transitory computer readable medium 1004 through communication link 1006. In an example implementation, the computing environment 1000 may be for example, the system 106 for leak detection. In an example, the processor 1002 may have one or more processing resources for fetching and executing computer-readable instructions from the non-transitory computer readable medium 1004. The processor 1002 and the non-transitory computer readable medium 1004 may be implemented, for example, in the system for instantaneous leak detection of a compound associated with an asset.

The non-transitory computer readable medium 1004 may be, for example, an internal memory device or an external memory. In an example implementation, the communication link 1006 may be a network communication link, or other communication links, such as a PCI (Peripheral component interconnect) Express, USB-C (Universal Serial Bus Type-C) interfaces, I2C (Inter-Integrated Circuit) interfaces, and the like. In an example implementation, the non-transitory computer readable medium 1004 includes a set of computer readable instructions 1010 which may be accessed by the processor 1002 through the communication link 1006 and subsequently executed for instantaneous leak detection of a compound. The processor(s) 1002 and the non-transitory computer readable medium 1004 may also be communicatively coupled to a computing device 1008 over the network.

Referring to FIG. 10, in an example, the non-transitory computer readable medium 1004 includes computer readable instructions 1010 that cause the processor 1002 to receive data streams from a plurality of sensing elements associated with the asset. Where, the plurality of sensing elements are to at least detect leak attributes corresponding to the compound. A leak attribute is indicative of a potential leak of the compound. The instructions 1010 may further cause the processor 1002 to identify a first set of data streams which includes at least one leak attribute from amongst a pre-defined set of leak attributes. Further, the instructions 1010 may cause the processor 1002 to monitor the first set of data streams in real-time to identify a change in value of the at least one leak attribute.

The instructions 1010 may further cause the processor 1002 to analyze the change in value of the at least one leak attribute over a predetermined time period and determine presence of a leak of the compound when the change in value of the at least one leak attribute persists for the predetermined time period. The instructions 1010 may then cause the processor 1002 to identify a data stream associated with the at least one leak attribute to trace sensing elements amongst the plurality of sensing elements associated with the said data stream, contextualize the leak based on the traced sensing elements and provide the contextualized leak to a user interface. In one example, contextualizing the leak includes associating the leak with at least one of a leak ID, location of the leak, a leak start time, a leak end time, a leak area, a leak gas type, and a leak rate.

Although examples of the present subject matter have been described in language specific to methods and/or structural features, it is to be understood that the present subject matter is not limited to the specific methods or features described. Rather, the methods and specific features are disclosed and explained as examples of the present subject matter.

I/We claim:

1. A method for leak detection of a compound associated with an asset, the method comprising:
receiving data streams from a plurality of sensing elements associated with the asset, wherein the plurality of sensing elements are to at least detect leak attributes corresponding to the compound, a leak attribute being indicative of a potential leak of the compound;
identifying a first set of data streams which includes at least one leak attribute from amongst a pre-defined set of leak attributes;
monitoring the first set of data streams in real-time to identify a change in value of the at least one leak attribute;
analyzing the change in value of the at least one leak attribute to determine presence of a leak of the compound;
identifying a data stream associated with the at least one leak attribute to trace sensing elements amongst the plurality of sensing elements associated with said data stream;
contextualizing the leak based at least on the traced sensing elements; and
providing the contextualized leak to a user interface.

2. The method of claim 1, further comprising
identifying a plurality of leak attributes from amongst the pre-defined set of leak attributes, wherein the plurality of leak attributes includes the at least one leak attribute; and
ordering the plurality of leak attributes in correspondence to a time of detection for each leak attribute.

3. The method of claim 2, further comprising
grouping the ordered plurality of leak attributes in correspondence to a type of sensing mode, wherein each sensing mode is associated with one or more sensing elements amongst the plurality of sensing elements from which data streams including the leak attributes originate.

4. The method of claim 1, wherein analyzing the change in value of the at least one leak attribute comprises comparing the change in value of the at least one leak attribute with a set of pre-determined rules to determine presence of the leak of the compound.

5. The method of claim 1, further comprising:
converting the contextualized leak into leak emission data by calculating an equivalent amount of greenhouse gas emissions based on characteristics of the compound and the contextualized leak.

6. The method of claim 1, wherein contextualizing the leak comprises associating the leak with at least one of a leak ID, location of the leak, a leak start time, a leak end time, a leak area, a leak gas type, and a leak rate.

7. The method of claim 6, further comprising:
calculating the leak rate based on the change in value of the at least one leak attribute; and
estimating a quantity of the compound leaked based on the leak rate and a duration of the leak.

8. The method of claim 7, further comprising:
determining if the leak rate exceeds a predetermined threshold within a specified time period; and
flagging the leak as a critical leak event when the predetermined threshold is exceeded.

9. The method of claim 1, further comprising:
generating a work order based on the contextualized leak;
assigning the work order to maintenance personnel for leak remediation; and
tracking a status of the work order until the leak is resolved.

10. The method of claim 1, wherein contextualizing the leak further comprises:
identifying an asset associated with the traced sensing elements;
determining a location of the asset within a site; and
associating the leak with the identified asset and its location.

11. The method of claim 1, wherein contextualizing the leak further comprises:
analyzing whether the determined leak is a recurrent leak by comparing characteristics associated with the determined leak with characteristics of a historical leak; and
updating the contextualized leak.

12. A leak detection system, the system comprising:
a processor; and
a memory coupled to the processor, wherein the processor causes to:
receive data streams from a plurality of sensing elements associated with an asset, wherein the plurality of sensing elements are to at least detect leak attributes corresponding to a compound associated with the asset, a leak attribute being indicative of a potential leak of the compound;
identify a first set of data streams which includes one or more leak attributes from amongst a pre-defined set of leak attributes, wherein the first set of data streams includes a first set of leak attributes amongst the pre-defined set of leak attributes and wherein each data stream amongst the first set of data streams includes at least one leak attribute;
monitor the first set of data streams in real-time to identify a change in value of at least one leak attribute from amongst the first set of leak attributes;
analyze the change in value of the at least one leak attribute in conjunction with values of other leak attributes from the first set of leak attributes to determine presence of a leak of the compound;
identify data streams associated with the leak attributes used to determine the presence of the leak to trace sensing elements amongst the plurality of sensing elements associated with the said data streams;
contextualize the leak based at least on the traced sensing elements; and
provide the contextualized leak to a user interface.

13. The system of claim 12, wherein the processor further causes to:
identify a plurality of leak attributes from amongst the pre-defined set of leak attributes, wherein the plurality of leak attributes includes the at least one leak attribute; and
order the plurality of leak attributes in correspondence to a time of detection for each leak attribute.

14. The system of claim 12, wherein analyzing the change in value of the at least one leak attribute comprises comparing the change in value of the at least one leak attribute with a set of pre-determined rules to determine presence of the leak of the compound.

15. The system of claim 12, wherein the processor further causes to:
convert the contextualized leak into leak emission data by calculating an equivalent amount of greenhouse gas emissions based on characteristics of the compound and the contextualized leak.

16. The system of claim 12, wherein contextualizing the leak comprises associating the leak with at least one of a leak ID, location of the leak, a leak start time, a leak end time, a leak area, a leak gas type, and a leak rate.

17. The system of claim 16, wherein the processor further causes to:
calculate the leak rate based on the change in value of the at least one leak attribute; and
estimate a quantity of the compound leaked based on the leak rate and a duration of the leak.

18. The system of claim 17, wherein the processor further causes to:
determine if the leak rate exceeds a predetermined threshold within a specified time period; and
flag the leak as a critical leak event when the predetermined threshold is exceeded.

19. A non-transitory computer-readable medium comprising instructions for leak detection of a compound associated with an asset, the instructions being executable by a processor to:
receive data streams from a plurality of sensing elements associated with the asset, wherein the plurality of sensing elements are to at least detect leak attributes corresponding to the compound, a leak attribute being indicative of a potential leak of the compound;
identify a first set of data streams which includes at least one leak attribute from amongst a pre-defined set of leak attributes;
monitor the first set of data streams in real-time to identify a change in value of the at least one leak attribute;
analyze the change in value of the at least one leak attribute over a predetermined time period;
determine presence of a leak of the compound when the change in value of the at least one leak attribute persists for the predetermined time period;
identify a data stream associated with the at least one leak attribute to trace sensing elements amongst the plurality of sensing elements associated with the said data stream;
contextualize the leak based at least on the traced sensing elements; and
provide the contextualized leak to a user interface.

20. The non-transitory computer-readable medium as claimed in claim 19, wherein contextualizing the leak comprises associating the leak with at least one of a leak ID, location of the leak, a leak start time, a leak end time, a leak area, a leak gas type, and a leak rate.
